(19) United States
(12) Patent Application Publication
(10) Pub. No.: US 2008/0148119 A1
(43) Pub. Date: Jun. 19, 2008

(54) Apparatus for Built-in Speed Grading and Method for Generating Desired Frequency for the Same

(75) Inventors: Shi Yu Huang, Hsinchu City (TW); Hsuan Jung Hsu, Chiayi County (TW); Chun Chien Tu, Chiayi County (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, Hsinchu (TW)

(21) Appl. No.: 11/612,945

(22) Filed: Dec. 19, 2006

(51) Int. Cl. G06F 11/27; G06F 11/263

(52) U.S. Cl. 714/733; 714/740; 714/E11.169; 714/E11.177

(57) ABSTRACT

A method for Built-In Speed Grading (BISG) comprises a Circuit Under Test (CUT) with Built-In Self-Test (BIST) circuitry, an All-Digital Phase-Locked Loop (ADPLL), and a BISG, to automatically decide the maximum operating frequency of the CUT. The search process for this maximum operating frequency is conducted by a binary search in which the next frequency to test CUT is determined automatically by the BISG controller based on whether the CUT passes or fails the BIST session at current frequency. The maximum operating frequency the CUT can operate is narrowed down to a fine-tuning range out of a number of clock frequencies that the ADPLL can offer. The frequencies an ADPLL can offer is divided into a plurality of coarse ranges, with each of them further having a plurality of fine-tuning frequencies. In this overall built-in speed grading process, each desired frequency to be used to test the CUT is generated by the ADPLL via a binary-neighborhood-linear locking scheme, so as to minimize the locking error between the desired frequency and the frequency actually produced by the ADPLL even under process variation. In this process, a desired clock frequency for a BIST session is locked in by the ADPLL in three steps: a quick binary search to find a coarse range of frequencies close to the desired frequency; a neighborhood checking around the selected coarse range in an attempt to find one that is even closer to the desired frequency; and finally an exhaustive or linear search within the final selected coarse range for a fine-tuning frequency that is closest to the desired frequency. Such a process provides better immunity to potential process variation under advanced technologies.

### BACKGROUND OF THE INVENTION

(A) Field of the Invention

The present invention relates to an apparatus for built-in speed grading (BISG) for a device under test (DUT) and a method for generating a desired frequency for a built-in self test (BIST) session in connection with the BISG.

(B) Description of the Related Art

The distribution of the maximum clock frequency a design can operate in silicon is often significantly influenced by the impact of environment fluctuations and/or process variations. It has been observed that speed variation of up to 30% is not unlikely. For various reasons, speed binning or speed grading might be needed during the manufacturing testing so as to quantify the speed characteristic of each individual chip. For example, chips that are found to be faster than the nominal speed can be sold at higher prices. Also, for certain low-yield situations, speed grading is the first step to find out the potential causes of performance degradation.

More recently, it was discovered that chips could run slower than their normal functional speed while undergoing structural testing. Yet, by correlation, chances are we might be able to bridge the two speeds and to avoid the over-killing. To enable such a correlation-based calibration, speed has to be tested for every chip.

Conventionally, speed grading has been conducted in several different ways, depending on the operation speed of the DUT. For a device with a relatively low clock speed, an external tester might be able to drive the device with various clock frequencies from the clock pad and measure the best speed. For a higher-speed device, such as a 1GHz microprocessor on-chip, Design-for-Testability (DfT) might be needed in order to produce the internal high-speed signals required. Sometimes the maximum operating speed is determined by measuring the propagation delay of a replica of a critical-path section in the device, while others may try to find out the maximum speed the DUT can pass for a pre-defined test suite, be it functional or structural. The former method based on replica measurement is more direct and cost-effective; however, it sometimes cannot truly reflect how fast a device can truly operate under various input stimuli, especially when all kinds of process variation effects kick in to cause deviation of the replica from the true critical path.

The bottom line for speed grading is to know the maximum speed at which a device can operate when it is mounted on its system board running real applications. However, sometimes this may be impractical during mass production testing. To achieve this objective, a hypothetical solution may look like this: Augment the design with a powerful programmable clock generator and a huge memory for storing the entire suite of functional patterns derived from typical applications. Use a controller, by hardwire or microcode, to regulate the multiple test sessions running the embedded functional patterns under varying clock frequencies and thereby determine its maximum operating speed.

Clearly, such a naive BISG idea is impractical, merely considering the area overhead. However, recent studies on the correlation between performance testing using functional patterns and structural patterns have come to the rescue. Belete et al. gauged the effectiveness of delay testing as compared to that of using functional patterns for speed grading. Cory et al. offered a formula to relate structural testing frequency to system operation frequency. Zeng et al. studied the links between the functional patterns and various types of structural patterns in terms of test frequency on a high-performance microprocessor.

In light of these recent advancements in speed grading, the time has come to develop the ability to efficiently perform not only built-in self-testing but also built-in speed grading.

### SUMMARY OF THE INVENTION

The present invention provides an apparatus for BISG for a DUT and a method for generating a desired frequency for a BIST in connection with the BISG, so as to determine the maximum clock frequency at which a DUT can operate. Therefore, the test can be more cost-efficient with reasonable overhead area.

In accordance with the present invention, an apparatus for BISG comprises an all-digital phase-locked loop (ADPLL), a circuit under test (CUT) with Built-In Self-Test (BIST) circuitry and a BISG controller. The ADPLL provides a plurality of desired clock frequencies to the CUT with BIST circuitry for conducting BIST sessions on a DUT. The BISG controller is configured to control the ADPLL and the CUT with BIST circuitry to find the maximum frequency the CUT can operate out of the plurality of desired clock frequencies. The clock frequency for the BIST session is decided by the BISG controller.

In accordance with an embodiment of the present invention, a binary search process is employed to find out the maximum frequency out of the plurality of desired clock frequencies, i.e., the desired clock frequency for next BIST session is generated based on whether the current BIST session is passed or failed.

Preferably, the BISG controller controls the ADPLL to generate the desired clock frequency through a locking scheme. First, a binary search process, i.e., coarse tuning process, is performed for a coarse range of clock frequencies that a digitally controlled oscillator in the ADPLL can offer, so that the coarse range is close to the desired clock frequency. Then, neighborhood checking is performed on a number of the clock frequencies around the coarse range to further decide a coarse-tuning range that is closest to the desired frequency so as to tolerate process variation. Sequentially, a linear search process, i.e., a fine-tuning process, is employed in the coarse-tuning range for a clock frequency that is closest to the desired frequency.

As mentioned above, a BISG methodology is built upon at-speed logic BIST architecture. An ADPLL is designed to synthesize various clock frequencies for tracking down the maximum operating frequency of a DUT into a fine speed range via a binary search process. Implementation down to layout shows that the extra area overhead beyond BIST is only modest for large designs.

Accordingly, many benefits are contributed. First, the on-chip functional test stimuli can be replaced by far cheaper structural tests or even random tests to make the area overhead reasonable. Second, designers can thus gain much more process variation information when the cost of BISG is affordable. In other words, previous process monitoring schemes using such as ring oscillators or delay measurement circuits can thereby be further leveraged to have more insight on how process variation and/or signal integrity influences a DUT's performance on a chip-to-chip basis. Third, BISG results could be valuable when debugging a product having a low or unstable yield. Last but not the least, BISG can also be used as an efficient means for calibrating away the over-testing problems happened to functioning chips that fail testing simply because of abnormal stress conditions during testing, e.g., excessive scan power and its induced performance degradation.

### BRIEF DESCRIPTION OF THE DRAWINGS

The objectives and advantages of the present invention will become apparent upon reading the following description and upon reference to the accompanying drawings in which:

FIG. 1 shows an embodiment of an apparatus for BISG in accordance with the present invention;

FIG. 2 shows an example of a binary search for the BISG in accordance with the present invention;

FIG. 3 shows an embodiment of an ADPLL of the apparatus for BISG in accordance with the present invention;

FIGS. 4, 5(a) and 5(b) show an embodiment of a DCO of the apparatus for BISG in accordance with the present invention;

FIG. 6 shows the relation between coarse control code and the frequency of a DCO;

FIG. 7 shows an embodiment of the control signals in the apparatus for BISG in accordance with the present invention;

FIGS. 8 and 9 show the relations between the final speed range and the test pattern number; and

FIG. 10 shows the area overhead for adding the BISG circuitry in a design.

### DETAILED DESCRIPTION OF THE INVENTION

First, BIST session and BISG session are defined as follows.

BIST Session: A BIST session refers to the time period in which a sequence of pseudo-random test patterns is applied to DUT and collect their responses compressed as a final signature over the time via Multiple Input Shift Register (MISR). Comparing the final signature with the golden signature will determine whether the DUT passes or fails the BIST session.

BISG Session: The BISG session is composed of several BIST sessions, each of which is tested with a different clock frequency. Starting from a pre-defined initial frequency, a binary search algorithm is used to determine the clock frequency of each BIST session until the maximum operating frequency is confined within a fine range.

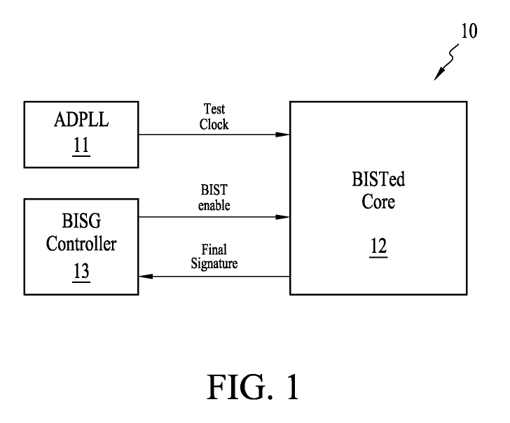

FIG. 1 shows the overall architecture of the apparatus of the Built-in Speed Grading in accordance with the present invention. An apparatus 10 for BISG comprises an ADPLL 11, a BISTed core 12 and a BISG controller 13, which are defined as follows:

BISTed Core: The Circuit Under Test (CUT) wrapped with Logic BIST circuitry is called a BISTed core for which the at-speed testing can be performed within the chip.

ADPLL: In order to find the maximum operating frequency a programmable clock generator is required to apply various test frequencies during at-speed testing. To enable higher portability across multiple technology platforms, a fully cell-based ADPLL is preferred.

BISG Controller: A controller regulates the overall flow in one BISG session. It is also responsible for communicating with the other two components, i.e., BISTed core and ADPLL. Moreover, according to the result of each BIST session, a new test frequency will be determined based on binary search.

The derivation of the CUT with BISG capability is done in two steps.

Step 1: The CUT is first wrapped with the logic BIST circuitry essentially including PRPG, MISR and the logic BIST controller, etc.

Step 2: After the BISTed Core is ready, the ADPLL and BISG controller are added to complete the CUT with BISG.

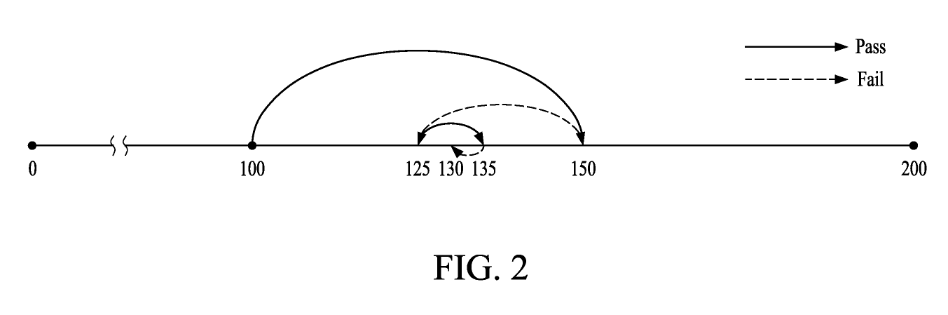

FIG. 2 shows an example of the binary search in one BISG session in accordance with the present invention. The initial test frequency can be derived based on some timing analysis tools. In this example, it is assumed that the initial test frequency is 100 MHz. After one BIST session a “passed” signature is received, and therefore another BIST session goes with a higher frequency, i.e., 150 MHz. At this time the signature is assumed to be “failing” so that the test frequency is slowed down to 125 MHz. After a number of BIST sessions the final speed range will be determined. It is shown that the maximum operating frequency in this example is located between 130 MHz and 135 MHz. Frequency 130 MHz is passed in the BIST session, whereas 135 MHz is failed in the BIST session.

The phase-locked loop (PLL) has been popularly used as a frequency synthesizer. A conventional PLL may consist of analog components that makes it sensitive to process variations and noise. In a BISG application, the all-digital phase-locked loop (ADPLL) is especially suitable since it can be fully constructed using standard cells.

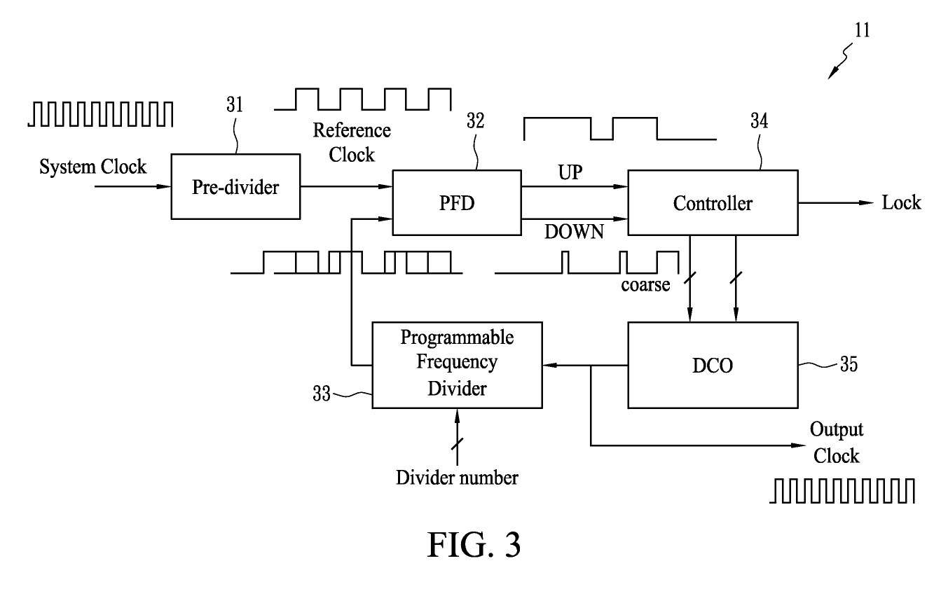

FIG. 3 shows an embodiment of the overall block diagram for the ADPLL 11. A pre-divider 31 is used to slow down the system clock to obtain a much slower reference clock, e.g., 2.5 MHz. The reference clock frequency has direct link to the resolution of the synthesized frequencies. The resolution here refers to the fine difference of two consecutive frequencies that can be synthesized by a clock generator. The Phase Frequency Detector (PFD) 32 is to measure the phase difference between the feedback divided clock and the reference clock. The feedback divided clock is simply the output clock with the frequency scaled down by N times through a programmable frequency divider 33. The PFD 32 generates two mutually exclusive signals: lead and lag. When signal lead (lag) is high, it means that the clock edge of the feedback divided clock is leading (lagging) that of the reference clock. By observing the waveforms of these two signals, the next control code for the Digitally Controlled Oscillator (DCO) 35 can be determined.

The frequency of the clock signals generated by the DCO 35 is controlled by a digital code with six coarse-tuning bits and four fine-tuning bits. The DCO 35 is often regarded as the most critical part among these components because it dictates the frequency range and the resolution that an ADPLL can synthesize. The PFD 32 determines the relationship between the reference clock and the desired output clock. Ideally, the output frequency is the reference frequency multiplied by a divider number. For example, if the reference frequency now is 2.5 MHz, the divider number needs to be assigned as 40 in order to produce 100 MHz output frequency. A controller 34 is used to determine the control code for tuning the frequency of the DCO 35 by checking the output waveforms of the PFD 32. After a number of reference clock cycles, the control code will remain constant and the output frequency will become stable, indicating that the ADPLL has been locked at a desired frequency.

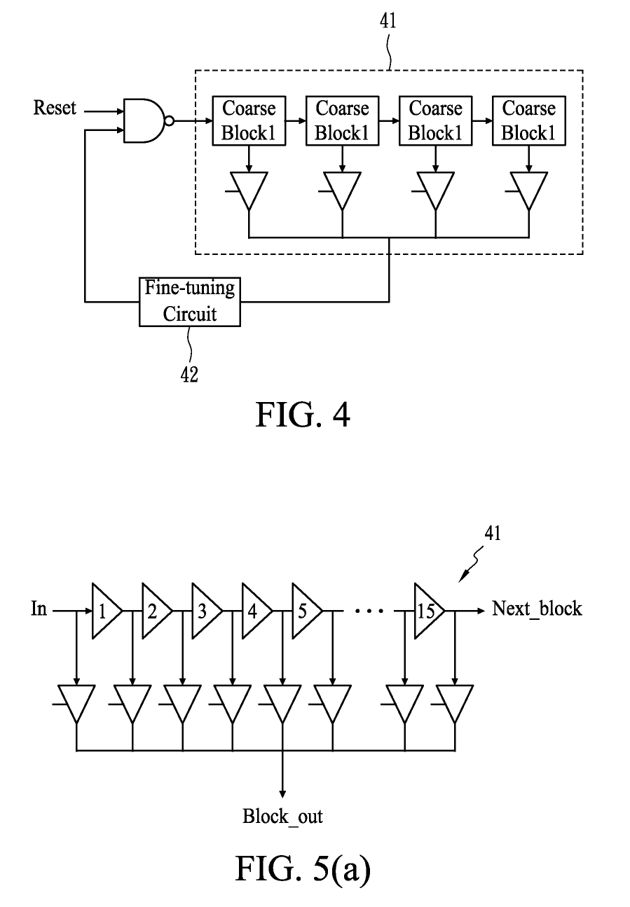

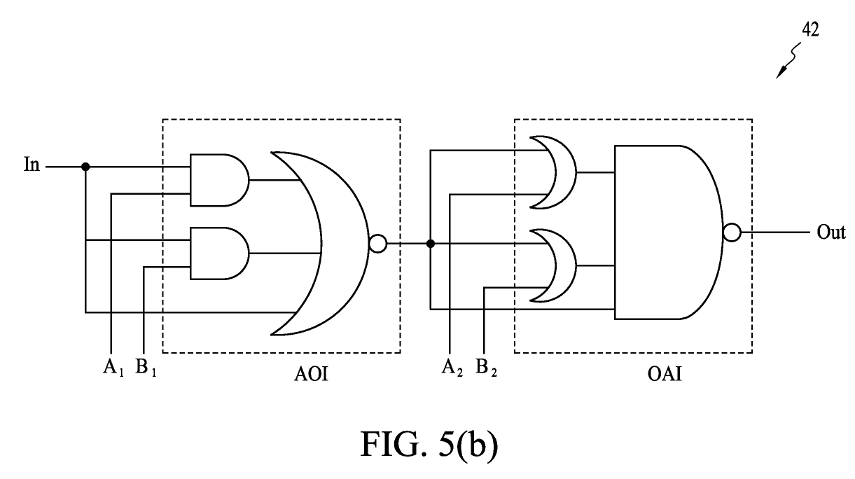

As mentioned above, the design of the DCO 35 will significantly affect the performance of the ADPLL 11. In our application higher resolution is demanded so as to reduce lock errors between the synthesized frequency and the desired frequency. The design of the DCO 35 is based on the structure proposed by C.-C. Chen et al., “An All-Digital Phase-Locked Loop for High Speed Clock Generation,” IEEE Journal of Solid-State Circuits, 2003, pp. 347-351, which is composed of only standard cells, as 15 shown in FIG.4. It can primarily be separated into two main parts. One is the coarse-tuning circuitry 41 consisting of a series of buffers as a delay chain as shown in FIG. 5(a). By controlling the number of buffers involved in the delay chain, the period of the ring oscillator can be controlled. For example, the delay loops of coarse code ‘60’ and coarse code ‘59’ are only different by one buffer delay. The second part is the fine-tuning circuitry 42 made of several delay paths as shown in FIG. 5(b). The delay differences of these paths are made as small as possible to increase the resolution of the clock frequencies that DCO can synthesize.

The frequency generated by the DCO 35 can be approximately estimated by equation (1).

$${f}_{osc} \approx \frac{1}{2 ( N {τ}_{Buf} + {τ}_{Basic} + {τ}_{Fine - tuning} )} \\ where {τ}_{Basic} = 2 {τ}_{TBuf} + {τ}_{Nand} \qquad ( 1 )$$

f_{osc} is the clock frequency at which DCO 35 oscillates. N represents the number of buffers involved in the ring oscillator's delay loop. A larger value of N means a lower frequency oscillated. τ_{Buf} represents the propagation delay of the buffer. Similarly, τ_{TBuf} and τ_{Nand} are the propagation delays of the tri-state buffer and the NAND gate, respectively and τ_{Fine-tuning} is the delay of the fine-tuning circuit 42.

The 6-bit coarse-tuning bits and 4-bit fine-tuning bits constitute 2¹⁰=1024 different clock frequencies that DCO can generate. The operation of an ADPLL is not like its analog counterpart, which continuously synchronizes with the input reference clock. Instead, an ADPLL undergoes a locking procedure once initiated and then settles down to a lock state, in which the control code remains unchanged. The locking procedure aims to select one frequency closest to a desired frequency out of the 1024 possible frequencies that DCO can offer. This is a search problem. The search algorithm implemented by the controller will affect both the lock time and the lock error.

A binary-neighborhood-linear algorithm is employed to minimize these two criteria simultaneously, thereby providing test clocks, i.e., desired clock frequencies, to the BISTed Core 12 for conducting BIST sessions.

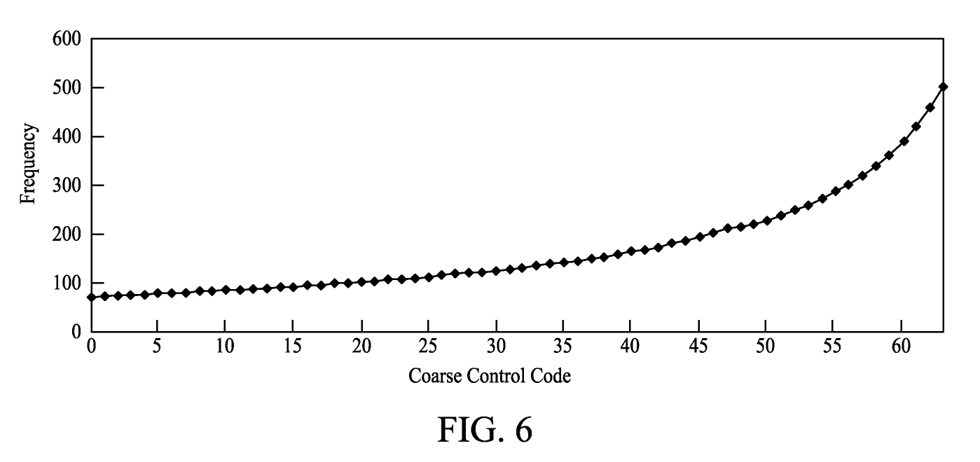

Phase 1: (Binary Search) As the coarse control code increases, the number of buffers selected decreases so that the output frequency increases monotonously, as shown in FIG. 6. Consequently, the coarse code that matches the desired frequency most can be quickly derived through binary search. In other words, binary search is employed to quickly find a coarse range of clock frequencies that a digitally controlled oscillator (DCO) in the ADPLL can offer, so that the coarse range is close to the desired frequency.

Phase 2: (Neighborhood Checking) For devices using advanced technologies, it cannot be ruled out that severe process variation could break the monotonicity of the coarse-tuning circuit. It is noteworthy that the lock error is basically dominated by the coarse-tuning code. If the coarse-tuning code is not 100% correct, then the fine-tuning code cannot recover from the error. In order to accommodate the process variation, a variation-tolerant trick is introduced. A number of neighboring codes around the one selected in Phase 1 are further checked to look for even better coarse-tuning range. By doing so, the selected coarse-tuning code is ascertained to be the local optimum.

Phase 3: (Linear Search) In our fine-tuning circuitry the monotonicity does not exist. In other words, a larger fine-tuning code does not necessarily correspond to a higher clock frequency even under perfect processing technology. In order to minimize lock error, falling back on a linear search process. Through the linear search, a clock frequency in the coarse-tuning range that is closest to the desired frequency is determined.

Let T_{check} denote the number of clock cycles ADPLL requires in order to estimate how close a DCO frequency is to a given desired frequency. Then the above binary-neighborhood-linear algorithm will require about (6+2+16)=24 T_{check} clock cycles to lock down the DCO frequency. As compared to the linear search that takes 1024 T_{check} clock cycles, the rate is about 42.6 times greater.

The BISG controller 13 is responsible for the whole operation flow in one BISG session. When one BISG session starts, the initial divider number should also be sent to the BISG controller 13. The initial divider number can be obtained from some timing analysis tool to reduce the test time. The test frequency range can be defined based on the initial divider number. In our experiment the test frequency range is preset as ±100 MHz around the initial frequency. In other words, if the timing analysis tool reports a maximal clock frequency of 200 MHz, then the frequency range from 100 to 300 MHz will be our target search range.

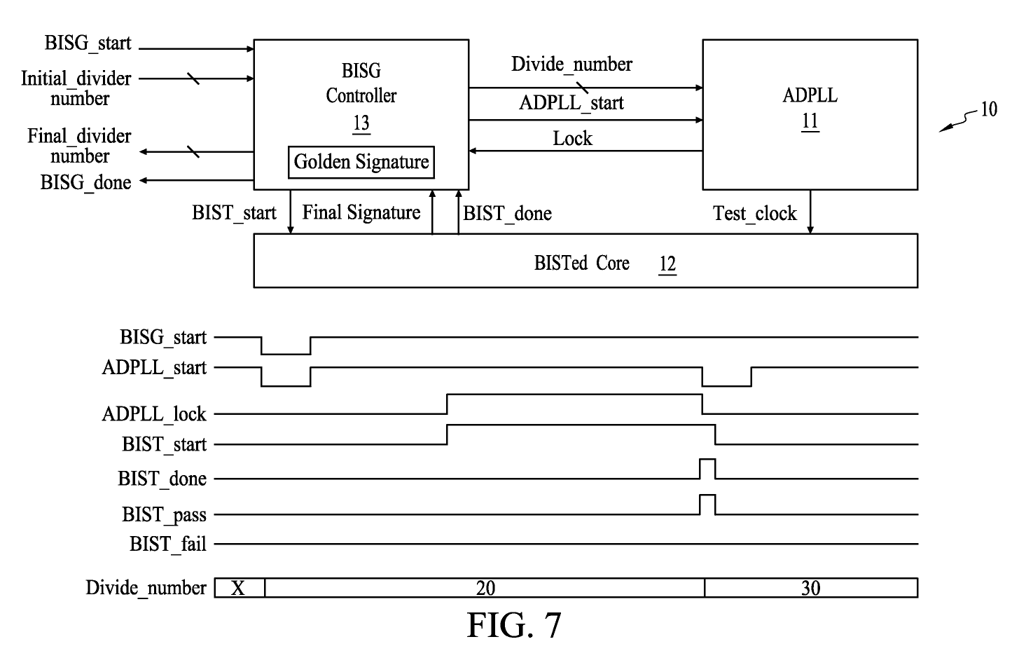

FIG. 7 shows the detailed control and data signals between the three main components in the BISG architecture 10 as well as an example of a timing diagram thereof. One BISG session starts with BISG_start signal and then the initial divider number is applied to the ADPLL 11 via the BISG controller 13. After the lock time required by the ADPLL 11, the DCO of the ADPLL 11 will oscillate at a stable frequency close to the desired one and the BISG controller generates a BIST_start signal to initiate a BIST session with the synthesized frequency. The BIST session comes to an end when all test patterns generated have been executed and compressed by the MISR as a final signature. This final signature will be compared with the on-chip golden signature to decide if the DUT passes or fails this BIST session. According to the results of the present BIST session, the BISG controller will assign a new divider number to generate the test frequency for the next BIST session. Several BIST sessions are required to find the final speed range for the CUT. The BISG_done is not triggered until the final speed range is found, signaling the end of a BISG session.

Experiments are performed on ten benchmark circuits. Five of these are in-house designs, named GCD, MON, FIR, Viterbi, and AES. The GCD is a design that computes the greatest common divisor of two positive integers. The MON does the Montgomery inverse computation needed in an RSA data encryption circuit. The Viterbi is a channel decoder that extracts the original bit-stream at the receiver in a communication system. The FIR is a digital finite impulse response filter. The AES is a standard symmetric encryption/decryption processor.

The other five are selected from ISCAS' 89 benchmark circuits with bigger sizes. All of these benchmark circuits are wrapped with Logic BIST circuitry by SynTest TurboBIST for at-speed testing. Table 1 shows a summary of the circuits incorporated with Logic BIST. The definition of each column in Table 1 is depicted as follows:

(1) Size: This indicates the overall gate count of the circuit.

(2) Scan FF's : This indicates the total number of flip-flops in the scan chain.

(3) Scan Chain Number: This indicates the total scan chain number in the design.

(4) Test Point Insertion: This indicates the respective number of control points and observation points inserted into the design to increase the fault coverage.

(5) Fault Coverage: This indicates the fault coverage derived from fault simulation after test point insertion.

TABLE 1
Summary of CUT with Logic BIST

| | | | Scan Chain | Test Point | Fault Coverage |
|---|---|---|---|---|---|
| Design | Size | Scan FF's. | Num. | Insertion | (2048 patterns) |
| GCD | 1655 | 66 | 2 | 13/60 | 97.18% |
| MON | 3517 | 202 | 6 | 51/95 | 95.47% |
| FIR | 11212 | 160 | 5 | 0/0 | 97.66% |
| Viterbi | 9370 | 614 | 20 | 100/81 | 96.53% |
| AES | 28043 | 1217 | 40 | 20/20 | 97.51% |
| s13207 | 4242 | 647 | 20 | 83/69 | 90.1% |
| s15850 | 4458 | 560 | 20 | 53/89 | 92.17% |
| s35932 | 13200 | 1728 | 50 | 0/100 | 88.73% |
| s38417 | 11652 | 1564 | 50 | 100/94 | 92.15% |
| s38584 | 11812 | 1300 | 40 | 100/98 | 93.59% |

In order to obtain more realistic timing information, the layout is implemented and the SDF (Standard Delay Format) file of each BISTed core is extracted in an Automatic Placement & Routing (APR) tool, Astro. For timing simulation, a gate-level simulation with back-annotated SDF file is conducted. For static timing analysis, the embedded Static Timing Analysis (STA) tool in Astro is used.

The characteristics of this ADPLL are derived by quick SPICE simulation using NanoSim as shown in Table 2. It is shown that this ADPLL is able to synthesize 1024 clock frequencies ranging from 80 MHz to 540 MHz. The lock error for a randomly given frequency is 0.7% on the average and 2.07% in the worse case. Out of 10,000 cycles of clock waveform by NanoSim, 90 ps of peak-to-peak jitter and 22.4 ps of Root-Mean-Square (RMS) jitter are observed when the ADPLL oscillates at the highest frequency, 540 MHz.

TABLE 2
Characteristics of the ADPLL.

| | |
|---|---|
| Process | TSMC 0.18 μm CMOS |
| Area | 0.082 mm² |
| Max. Frequency | 540 (MHz) |
| Min. Frequency | 80 (MHz) |
| Average Resolution | 12 (ps) |
| Max. Lock Error | 2.07% @505 MHz |
| Average Lock Error | 0.7% |
| Max. Lock Time | 196 reference clocks |
| Jitter_{p—p} (@ 540 MHz) | 90 (ps) |
| Jitter_{RMS} (@ 540 MHz) | 22.4 (ps) |

Table 3 shows the final speed range reported by our post-layout gate-level simulation for BISG, compared to the timing report generated by Astro. The simulation takes quite some time for larger design blocks; hence, only 2048 test patterns are simulated in each BIST session. The definition of each column in Table 3 is depicted as follows:

(1) Astro Timing Report: This indicates the timing report generated by the STA tool embedded in Astro.

(2) Final Speed Range Simulated by BISG: This indicates the range of the maximal valid clock frequency located after the BISG simulation.

(3) Number of BIST sessions: This indicates how many BIST sessions were needed to find out the final speed range on the average.

TABLE 3
Final speed range by BISG simulation

| | | Post-layout Simulation (2048 patterns) | |
|---|---|---|---|
| | Astro Timing | Final Speed Range | Number of BIST |
| Design | Report (MHz) | Simulated by BISG (MHz) | Sessions |
| GCD | 126.7 | 180–185 | 4 |
| MON | 143.4 | 155–160 | 4 |
| FIR | 111.6 | 110–115 | 4 |
| Viterbi | 112.1 | 115–120 | 5 |
| AES | 100 | 100–105 | 5 |
| s13207 | 113.8 | 165–170 | 6 |
| s15850 | 115.3 | 175–180 | 5 |
| s35932 | 95.4 | 145–150 | 5 |
| s38417 | 107.8 | 115–120 | 4 |
| s38584 | 114.6 | 170–175 | 5 |

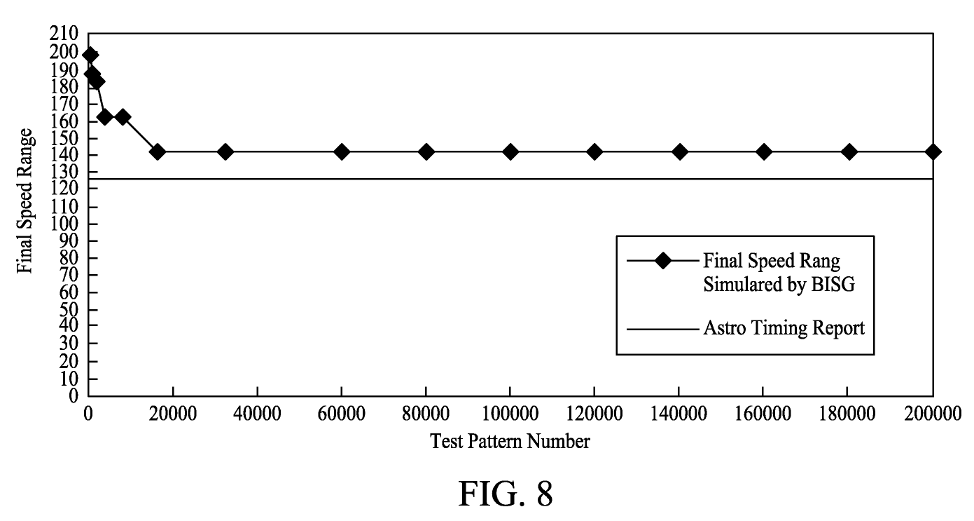

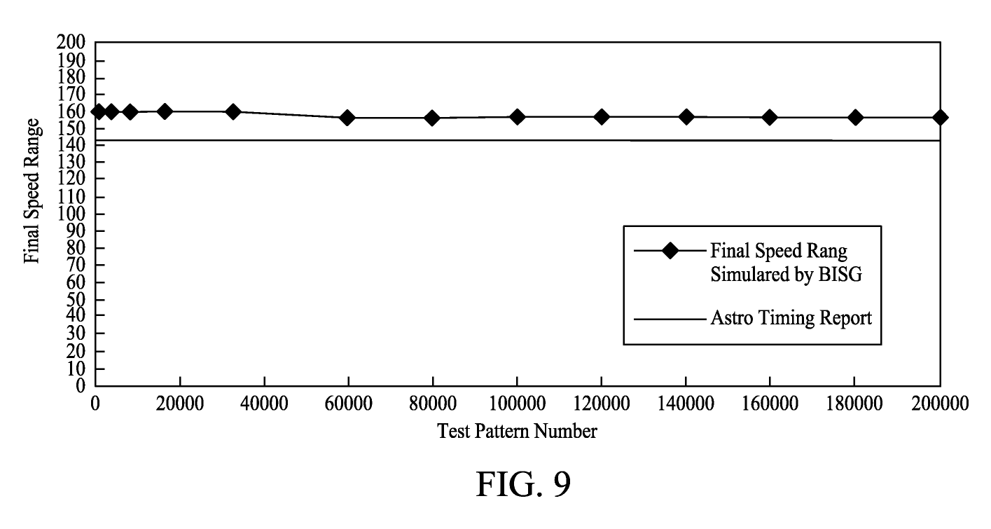

In accordance with Table 3, the speed reported by BISG simulation is in general more optimistic than that reported by an STA tool. There are a few factors that might have contributed to this result. First, the STA is known to be a worst-case approach that tends to be pessimistic. Second, the number of test patterns simulated has been limited to 2048 test patterns due to the long simulation time. With more test patterns simulated, the speed reported by BISG will be slower and closer to that reported by an STA tool. FIG. 8 and FIG. 9 show how the speeds reported by BISG vary over the number of test patterns simulated for two design blocks, GCD and MON, respectively.

Still, the final speed by BISG saturates at a higher frequency than that given by the Astro timing report. The maximal frequency reported by Astro is 126.7 MHz for GCD and the final speed range simulated by BISG is located between 140 MHz and 145 MHz. Similarly, the maximal frequency reported by Astro is 143.4 MHz for MON and the final speed range simulated by BISG lies between 150 MHz and 155 MHz.

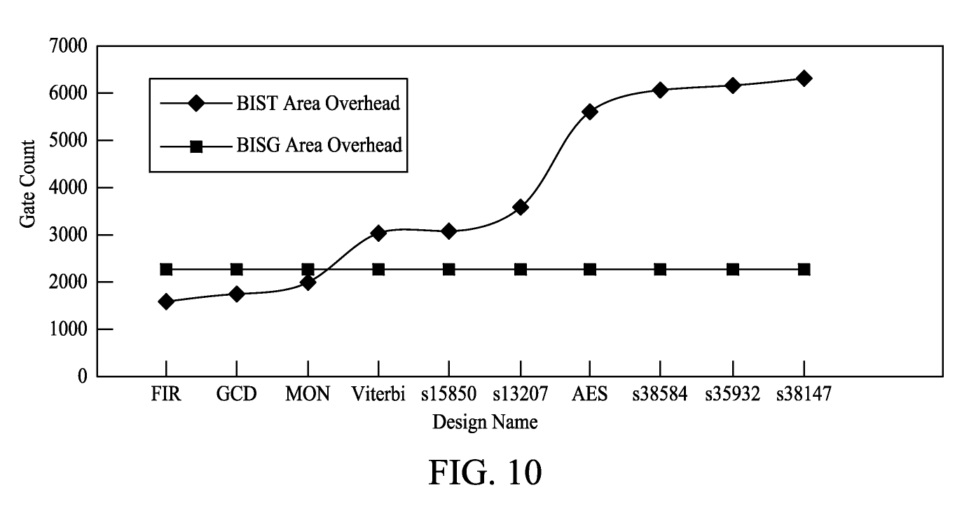

FIG. 10 shows the area overhead for adding the BISG circuitry to a design. Unlike the BIST in which the area overhead grows proportionally with the design sizes, the extra overhead of BISG is somewhat constant, roughly a gate count of 2289. This implies that once logic BIST is selected as a test solution, BISG could be an intriguing add-on feature.

Speed grading is valuable in many facets, e.g., device pricing, process monitoring, performance debugging, speed calibration, etc. Pursuant to recent developments in ADPLL design and speed correlation between structural tests and functional tests, it has become not just practical but also cost-effective to perform built-in speed grading. In accordance with the present invention, a methodology and its implementation for some ISCAS benchmark circuits and some real-life designs are present to validate its feasibility. It has been shown that current ADPLL design techniques have made on-chip programmable clock generators not only easy to design but also portable among different technology platforms. By our binary-neighborhood-linear locking algorithm, post-layout characterization indicates that a randomly given desired clock frequency can be locked down efficiently within 0.7% error on average. The proposed BISG methodology does require more test time than BIST, e.g., 4.7 times BIST sessions in order to narrow down the maximum operating frequency through binary search. Yet, the area overhead is estimated to have just 2289 equivalent 2-input NAND gates.

The above-described embodiments of the present invention are intended to be illustrative only. Numerous alternative embodiments may be devised by those skilled in the art without departing from the scope of the following claims.

What is claimed is:

1. An apparatus for built-in speed grading for a device under test (DUT), comprising:
a Phase-Locked Loop (PLL);
a circuit under test (CUT) with built-in self test (BIST) circuitry for conducting a BIST session for the DUT at each of a plurality of clock frequencies generated by the PLL; and
a BISG controller controlling the PLL and the CUT with BIST circuitry to find the maximum frequency the CUT can operate out of the plurality of clock frequencies.

2. The apparatus for built-in speed grading of claim 1, wherein the clock frequency for each of the BIST sessions is decided by the BISG controller based on a binary search process.

3. The apparatus for built-in speed grading of claim 1, wherein the clock frequency for next BIST session is decided by the BISG controller based on whether the current BIST session is passed or failed.

4. The apparatus for built-in speed grading of claim 1, wherein the controller compares a final signature produced by the CUT with BIST circuitry with a golden signature to determine whether the BIST session is passed or failed.

5. The apparatus for built-in speed grading of claim 1, wherein each of the plurality of clock frequencies is a reference frequency multiplied by a number.

6. The apparatus for built-in speed grading of claim 1, wherein the PLL comprises a digitally controlled oscillator (DCO), and the plurality of clock frequencies are selected from possible frequencies that the DCO can offer.

7. The apparatus for built-in speed grading of claim 1, wherein the PLL is an All-Digital Phase-Locked Loop (ADPLL).

8. The apparatus for built-in speed grading of claim 7, wherein the BISG controller controls the ADPLL to generate a desired clock frequency for current BIST session through a locking scheme comprising three steps:
performing binary search quickly for a coarse range of the clock frequencies that a digitally controlled oscillator (DCO) in the ADPLL can offer, so that the coarse range is close to the desired clock frequency; and
performing neighborhood checking on a number of the clock frequencies around the coarse range to further deciding a coarse-tuning range that is closest to the desired frequency so as to tolerate process variation; and
performing linear search within the coarse-tuning range of clock frequencies for a clock frequency that is closest to the desired frequency.

9. A method for generating a desired frequency for a BIST session with a built-in ADPLL, comprising three steps:
performing binary search quickly for a coarse range of clock frequencies that a digitally controlled oscillator (DCO) in the ADPLL can offer, so that the coarse range is close to the desired clock frequency; and
performing neighborhood checking on a number of the clock frequencies around the coarse range to further deciding a coarse-tuning range that is closest to the desired frequency so as to tolerate process variation; and
performing linear search within the coarse-tuning range of clock frequencies for a clock frequency that is closest to the desired frequency.
